(19) United States
(12) Patent Application Publication
(10) Pub. No.: US 2004/0024700 A1
(43) Pub. Date: Feb. 5, 2004

(54) Electronic funds transfer method and system

(76) Inventor: A. Michelle Petigny, New York, NY (US)

Correspondence Address: PENNIE AND EDMONDS, 1155 AVENUE OF THE AMERICAS, NEW YORK, NY, 100362711

(21) Appl. No.: 10/415,920

(22) PCT Filed: Nov. 29, 2001
(86) PCT No.: PCT/US01/44683

(51) Int. Cl. G06F 17/60

(52) U.S. Cl. 705/39; 705/42

(57) ABSTRACT

A method and system for effecting the transfer of electronic funds includes a computer that is in electronic communication with an electronic payment device reader, with a funds source account and with a funds collection account. A funds transfer request is received from the electronic payment device reader, and a server, initiates the transfer of funds from the funds source account to the funds collection account in response to an action at the electronic payment device reader. An enhanced point-of-sale device is one of many types of electronic payment device readers that may be used to transfer funds between accounts in accordance with embodiments of the invention.

This claims the benefit of co-pending U.S. Provisional Patent Application No. 60/253,666 filed Nov. 28, 2000 and No. 60/292,911 filed May 24, 2001, the contents of which are hereby incorporated by reference in their entirety.

### BACKGROUND OF THE INVENTION

Field of the Invention

The present invention relates to retail financial services and more particularly to an electronic funds transfer management system.

### BACKGROUND OF THE INVENTION

There are many known ways of paying for goods and services, including the use of credit cards, debit cards, and perhaps most obviously, the use of cash. While cash is still very widely accepted, the use of electronic payment methods such as credit and debit cards has grown substantially throughout recent years, and has numerous benefits. For one thing, unlike cash, lost or stolen credit cards can be replaced fairly easily, often with little or no financial loss to their owner. Also, the value of the goods and services that can be purchased using credit and debit cards is limited only by the consumer's credit limit or bank account balance. This often makes them more convenient to use than cash, because the consumer will not have to estimate ahead of time the exact amount of the purchase that he or she plans to make.

While electronic payment methods are very desirable, these forms of payment are unavailable to some consumers. The ability to obtain credit cards typically hinges upon a background check that assesses the income level and credit worthiness of the consumer. Banking institutions will not issue credit cards to those consumers who do not meet their requirements. Debit cards are typically linked to checking, savings or other accounts that have been established with banking institutions. Because the required initial deposit and the fees that are charged to maintain accounts at banking institutions are often quite substantial, some consumers are unable to or refuse to engage in formal, institutional banking relationships. Consumers without bank accounts are typically foreclosed from obtaining debit cards.

Consumers that do not have credit and debit cards often arrange to receive the funds that they acquire in cash. When they must accept checks and money orders, these consumers quickly convert these forms of payment to cash at “check cashing” and other establishments that can accommodate them. These establishments often charge very high fees for their services. Also, consumers that are limited to conducting financial transactions in cash are eliminated from making purchases over the telephone, over the internet and from using other services that require the electronic payment of funds.

In addition, some consumers have personal, cultural or other beliefs that discourage them from using credit, and from making the financial and personal disclosures that are necessary to obtain credit cards and to open bank accounts. These persons may also be limited to the use of cash to purchase the products and services that they need. The use of cash presents additional dilemmas for consumers who spend their money in foreign countries, such as foreign born consumers who send money home to family members, or return to their countries of origin for personal or business reasons. When these consumers are limited to the use of cash, they risk traveling with large sums of money or sending cash through the mail. This is obviously undesirable, because, as stated earlier, cash is easily lost or stolen and it cannot be replaced.

Further, cash that will be spent in foreign countries will almost always have to be exchanged to the local currency before the consumer can purchase goods and services. This presents additional problems because it may be difficult for persons who are not in or near large cities to access a currency exchange, and because the exchange rates that are offered at such locations tend to be much less favorable than those that are offered by banks and other mainstream financial institutions.

### SUMMARY OF THE INVENTION

To overcome the disadvantages described above, the present invention relates to an electronic funds transfer management system that allows consumers to use cash to access the worldwide electronic financial transactions network. Use of the invention makes it possible for consumers to hand cash to a merchant, who can transfer the value of that cash to an electronic payment device. Thus, the invention provides a way for consumers that have thus far been limited to the use of cash to make payments electronically.

The invention also makes it possible for a consumer to transfer funds to one or more other authorized persons who have electronic payment devices that are associated with his stored value account This minimizes the risk that the funds will be lost or stolen during transit Whether held by the consumer or by authorized persons, electronic payment devices that are provided in accordance with the invention can be used to make purchases from merchants and to withdraw cash from banks and ATMs throughout the world. The invention, therefore, enables consumers to receive the most favorable exchange rates when the funds are accessed in foreign countries.

In accordance with some embodiments of the invention, a method of effecting an electronic funds transfer includes receiving a funds transfer request transmitted from an electronic payment device reader. The funds transfer request includes identifying information for a funds source account and a funds collection account, and includes a funds transfer amount that corresponds to a value of barter received by a direct or indirect user of the electronic payment device reader to cause transmission of said funds transfer request. Electronic value in an amount that corresponds to the transfer amount, is electronically debited from the funds source account and electronically credited to the funds collection account in accordance with the funds transfer request.

In another other embodiment of the invention, an electronic funds management system, includes one or more funds source accounts configured to supply funds and one or more funds collection accounts configured to receive funds, a computer in electronic communication with one or more electronic payment device readers, with the funds source accounts and with the funds collection accounts and a server configured to initiate the transfer of funds from at least one of the funds source accounts to at least one of the funds collection accounts in response to an instruction transmitted from the electronic payment device reader which thereby causes the computer to complete the funds transfer.

Still another embodiment of the invention includes an electronic payment device reader that is configured to provide funds source account information associated with a funds source account, to provide funds collection account information associated with a funds collection account and to provide a funds transfer request that includes a funds transfer amount, wherein a transmission of data from the electronic payment device reader causes the electronic debiting of funds from the funds from the funds source account crediting of funds to the funds collection account.

In accordance with the various embodiments of the invention, consumers can gain immediate access to the worldwide financial transactions network. In some embodiments, a personalized electronic payment device can be loaded at the point-of-sale with any requested value. In other embodiments, the invention includes a reloadable stored-value electronic payment device that has been preloaded with a set monetary value. The devices may be reloaded in amounts that are requested by the consumer, or in predetermined increments. In still other embodiments, the invention includes a disposable stored value electronic payment device. That is, the electronic payment device is a prepaid card, keytag or other device that holds is stored with the dollar amount that was prepaid when the consumer obtained the device. Each time the consumer used the device, the amount that he spends is deducted from the dollar amount remaining in the device. The consumer may reload the device as the balance diminishes. Stored value devices may be preloaded with a set monetary value, or with a value that is requested by the consumer.

In some embodiments of the invention, an electronic payment device includes a rigid substrate with a data storage region. In some embodiments, the electronic payment device is a card that looks similar to a credit or debit card, and at least a portion of the funds transfer information is magnetically stored in the data transfer region. In other embodiments, the payment device may look and operate like a smartcard, and at least a portion of the funds transfer information is stored in a solid-state memory in the data storage region. In still other embodiments, the device may be a smaller object that fits on a key chain, key tag, or a stylus shaped object that can be carried in a pocket or purse. Funds transfer information may be delivered by these devices in any appropriate manner.

In accordance with the invention, consumer spending is typically limited to the amount of money that has been credited to a customer, also referred to as being “loaded onto” the customer's associated electronic payment device. In some embodiments, the purchases that are made with the electronic payment device reduce the value of the consumer's account. While the invention allows consumer to make purchases without having to borrow money as with a credit card, the invention is not limited to such use, and it could be used in conjunction with a line of credit. Once a payment device is “loaded,” the consumer can also complete low cost money transfer transactions via well known and widely available financial networks from virtually anywhere in the world, without having a formal bank account, or a traditional debit or credit card.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein like reference characters denote similar elements throughout the several views:

FIG. 1 is a flow diagram which provides a generalized illustration of a prior art worldwide financial transactions network that may be accessed using embodiments of the invention;

FIG. 2 is a schematic diagram which show exemplary components of an electronic funds management system in accordance with embodiments of the invention;

FIGS. 3A and 3B are detailed illustrations of credit card-shaped electronic payment devices that may be used according to various embodiments of the invention;

FIG. 4 depicts an enhanced point-of-sale device, one type of electronic payment device that may be used with embodiments of the invention;.

FIG. 5 depicts a kiosk, another type of electronic payment device that may be used with embodiments of the invention;

FIG. 6 is a data flow diagram of the request for, approval of and actual transfer of funds in accordance with the invention.

FIG. 7 is a flow diagram that provides a general illustration of steps that may be followed to transfer available points/electronic credits to an electronic payment device in accordance with embodiments of the invention;

FIG. 8 is a flow diagram that illustrates steps that may be followed to transfer funds into a clearinghouse master account to a credit clearinghouse merchant account in accordance with embodiments of the invention;

FIG. 9 is a flow diagram that illustrates steps that may be followed to debit from a merchant clearinghouse account and credit primary and companion customer cards in accordance with embodiments of the invention.

### DETAILED DESCRIPTION OF THE PREFERRED EMBODIMENTS

The present invention includes a system and method for electronically transferring funds. While the invention can be used in many ways, in some embodiments, merchant identification information can be transmitted through an enhanced point-of-sale (POS) device either from an electronic memory or in response to the reading of a merchant card. An amount of money that a merchant desires to transfer from her commercial bank account to a financial clearinghouse master account can then be entered, value equal to the entered amount will be stored on the merchant's electronic payment device. These transfers from the merchant's commercial bank account will typically take place on a daily, weekly, monthly or other periodic basis.

A consumer may then enter the merchant's establishment, and hand her cash along with a primary stored value card, one of several types of electronic payment devices that may be used with the invention. In some embodiments, the electronic payment device is a rigid substrate with a magnetic strip on the back, similar in appearance to well known credit and debit cards. The primary stored value card may also include a logo or other identifying trait that shows that it may be used to access the worldwide financial transactions network. In one embodiment, merchant identification information is provided via reading of a merchant card, and the merchant provides the merchant card to identify herself and her individual account(s). In such an embodiment, the merchant will typically then swipe the consumer's primary card at the enhanced POS device, or otherwise enter the primary account information at the electronic payment device, and enter a funds transfer command, to cause the designated amount of funds to be debited from the merchant's account at the financial clearinghouse or other affiliated institution and credited to the consumer's primary account and/or stored value card at the same or affiliated institution. The primary card will thereby be loaded with a cash value that corresponds to the amount that the consumer handed to the merchant. The amount that is actually loaded may be the exact amount of the cash that was handed to the merchant, it may be a lesser amount to incorporate a fee, or it may even be a greater amount to incorporate, for example, an incentive. The financial clearinghouse and/or commercial bank or affiliate may optionally generate an approval code receipt to assist the consumer's record keeping.

In accordance with embodiments of the invention, the consumer's companion(s) may also gain instantaneous access to electronic money through the use of a companion card, or other companion electronic payment device that may be used with the system. The companion card will typically, but not necessarily, be an electronic payment device that is similar in appearance to the primary stored value card or other primary electronic payment device. It will typically be linked to a primary card. More specifically, the companion card will be set up by the primary card holder, to receive credits from the primary account. The companion card holder will then be able to withdraw those funds from the clearinghouse master account using the companion card. Thus, the primary card holder can provide the companion account holder with instantaneous access to the transferred funds, anywhere in the world that credit or debit cards are accepted.

In accordance with various embodiments of the invention, consumers and merchants use customer cards (primary or companion) and merchant cards to communicate with financial clearinghouse servers to: enable a merchant to transfer funds to the clearinghouse master account and credit (i.e. “load”) her merchant card, to enable a merchant to load a consumer's primary card, and to enable a consumer to load a companion card.

Generally speaking, funds transfer requests credits and debits are executed in response to entry of a funds transfer command. In some embodiments, a funds transfer request is entered when a merchant enters a “buy” command which is communicated to the financial clearinghouse. The buy command is typically executed by pressing one or more buttons which have been preprogrammed on an enhanced POS device for this purpose. More specifically, in some embodiments, the merchant swipes her merchant card and presses a buy button on a key pad. If the merchant identification information has been pre-programmed into the enhanced POS, the merchant can simply press the buy button without swiping a merchant card. Pressing of the buy button is perceived by the clearinghouse computer as a request by the merchant to transfer funds from the merchants commercial bank account to the master account at the clearinghouse. The merchant may optionally be required to enter a security code or personal identification number (“PIN”), to ensure that withdrawal of funds from her commercial bank account is authorized. The merchant will typically also enter the amount of money that will be transferred.

Once the steps described above have been completed, a consumer can get a merchant to debit funds from her merchant account to load his customer cards. For example, the consumer can hand cash and a primary card to the merchant, who may then swipe the primary card and press a “sell” button, which has also been preprogrammed on the enhanced POS device. The merchant will typically also enter a value that corresponds to the amount tendered by the consumer. When the merchant presses the sell button in conjunction with the swiping of the consumer's primary card, the merchant clearinghouse account is debited and the customer's primary account is credited in the amount (or an amount that corresponds to the amount) tendered by the customer.

As long as there is credit in the primary account, the consumer can solicit the services of the merchant, to transfer all or a portion of that credit to a companion. It should be noted that some of the credit transfers that take place in accordance with various embodiments of the invention can also take place using the telephone or a website or other communication system that is set up by the clearinghouse or an associated entity. To transfer credit to companions, the merchant typically swipes the consumer's primary card and presses the sell button, to forward the consumer's request to the clearinghouse. The clearinghouse will then debit funds from the primary card and credit the selected companion card.

In some embodiments the companion card holder will receive a credit notification indicator after a credit has been posted. This credit notification indicator may be transmitted via phone lines or wirelessly, such as via e-mail, pager, to a personal digital assistant or via a standard telephone call.

While the invention has been described as “swiping” the card to enter the information stored on it, it should be understood that the identifying information may be typed, wirelessly communicated or otherwise entered into the POS device for transmission to the financial clearinghouse. Regardless of how the primary account is identified, the merchant identification information will be transmitted to the financial clearinghouse with all or a portion of the identifying information from the designated recipient's companion card, or any other way in which the companion account may be identified, along with the amount that is to be credited.

There is a chance that when the merchant swipes her card and presses the sell button that the transaction request will be denied. Reasons for such a denial include: (1) the consumer's use of an invalid card (e.g. canceled, reported lost or stolen, etc.); and (2) the merchant card posted credits are not sufficient to satisfy the customer's request. A denial for the latter reason will simply require the merchant to reload her own card before she can assist the consumer.

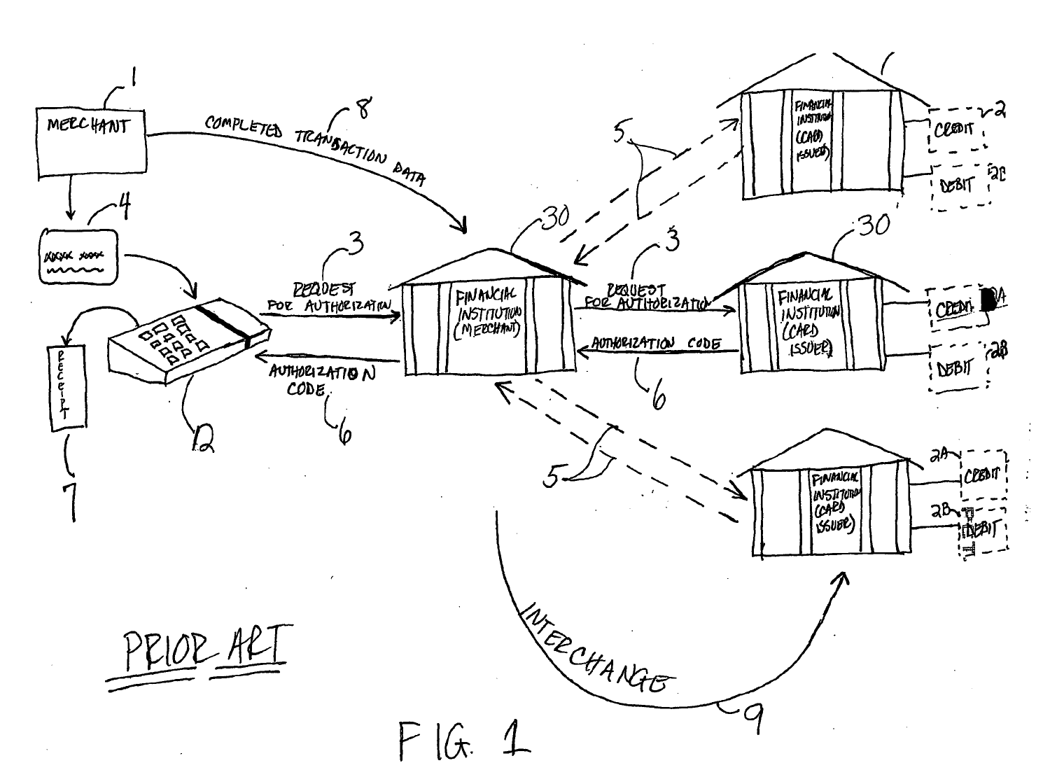

Referring now to the drawings which are provided to describe embodiments of the invention and not by way of limitation, FIG. 1 provides an overview of the worldwide financial transactions network which, generally speaking, is a system for electronically transferring funds between networked entities, in which the present invention may be used. During a traditional credit (or debit) card transaction, a merchant 1 swipes a buyer's card 4 through a POS device 12, and the amount of the purchase is either typed in by the merchant or transmitted directly from a cash register. The numbers that are embossed on the surface of the buyer's credit or debit card 1 identify type of bank card, the specific bank or other financial institution that issued the card, and the cardholder's account. This data, along with the purchase amount and request for authorization are transmitted to the financial institution 30 where the merchant's funds are located, as illustrated by arrow 3.

The merchant's financial institution typically forwards the request for authorization to the financial institution 30 that issued the buyer's card. While the merchant's bank and the card issuing bank will often be different financial institutions, it is possible for them to be located at the same financial institution. If the cardholder has enough available credit (in the case of a credit card account 2A) or available funds (in the case of a debit card account 2B) the card issuing financial institution 30 will authorize the transaction, place a hold on the cardholder's account for the amount of the sale, generate an authorization code and transmit the authorization code to the merchant's financial institution as indicated by arrow 6. If the buyer does not have enough available funds, the card issuing bank will not authorize the sale, no authorization code will be generated and the merchant will know (or be notified) to cancel the sale. It should also be noted that each POS device has an identification code that is used to make sure that the various financial institutions 30 communicate with the device that requested authorization for a particular transaction. Once the merchant's bank receives the authorization code, it sends it to the appropriate POS device, using this identification code. The POS device then prints out a sales draft 7, which can be signed by the buyer.

It should be noted that in many transactions, no funds will have actually been charged to the buyer's credit card 2A or debit card 2B account at this point This is because most merchants will wait until some later time (e.g. after the close of business) to review the authorizations that have been stored in the POS and compare them with the sales drafts that have been signed by the buyers, before they finalize the completed transactions. However, waiting is not required, and a merchant could choose to transmit this data from the POS device as soon as each sale is made. In any event, the merchant transmits the data from each completed transaction to its own financial institution as shown by arrow 8. After the data from the completed transaction is transmitted to the merchant's financial institution 30, the financial institution performs an “interchange” with the card issuing financial institutions 30 that authorized each transaction as shown by arrow 9. That is, throughout a given time period, merchants typically transact business with numerous buyers, and request authorization for transactions from many different card issuing financial institutions, each of which is capable of communicating with the merchant's financial institution as indicated by arrows 5. During an interchange, each card issuing financial institution 30 that authorized a transaction transfers the authorized amounts from the buyers' credit card 2A and debit card 2B accounts to the merchant's financial institution. The merchant's financial institution then deposits the funds that are received from the card issuing financial institutions 30 into the merchant's bank account. The financial institutions 30 that are involved in these transactions typically deduct transaction fees before transferring these funds to the merchant.

A standard POS device that can typically be found in most retail stores is an electronic box that enables merchants to communicate via a modem and telephone directly with their bank which can obtain information from other banks in the network. As indicated above, each POS device has an identification code that is used to make sure that the merchant's bank communicates with the device that requested authorization for a particular transaction. Thus, a merchant that has two or more POS devices can still determine which POS was involved in the processing of any particular transaction. More general information that identifies the merchant may also be programmed into the POS device. Customer identifying information will typically come from the customer card. In accordance with the invention, additional functionality may be programmed into a POS device that is connected to the financial clearinghouse or other middle-office network. Such a device can allow merchants to participate in the conversion and distribution of electronic funds. While an electronic box such as that described above may be used with the invention, acceptable POS devices also include computer networks (including the internet), and buy or sell commands may be entered by pressing one or more keys on a keypad or keyboard, by touching designated regions on a touchscreen, and other appropriate ways.

Electronic funds transfers also take place over the Internet. To complete such a transaction, a customer or his designee typically types in his debit card or bank account credit card number, and other verification information, such as the expiration date of the card, the customer's address, phone number and possibly a PIN. This information is the encoded and transmitted over the World, Wide Web to the appropriate location. There are also other types of electronic funds transfers. For example, smartcards are typically rigid substrates with a chip having solid state memory embedded therein. The memory records pertinent information for the last transaction, such as an account number, balance, available funds information, etc. The card is placed inside or near a smartcard reader that is capable of extracting the information as necessary while POS devices, internet browsers and smartcards may readily be used with the invention, any system or device that is capable of transmitting unique merchant and customer identification information to a clearinghouse for verification and settlement may be used.

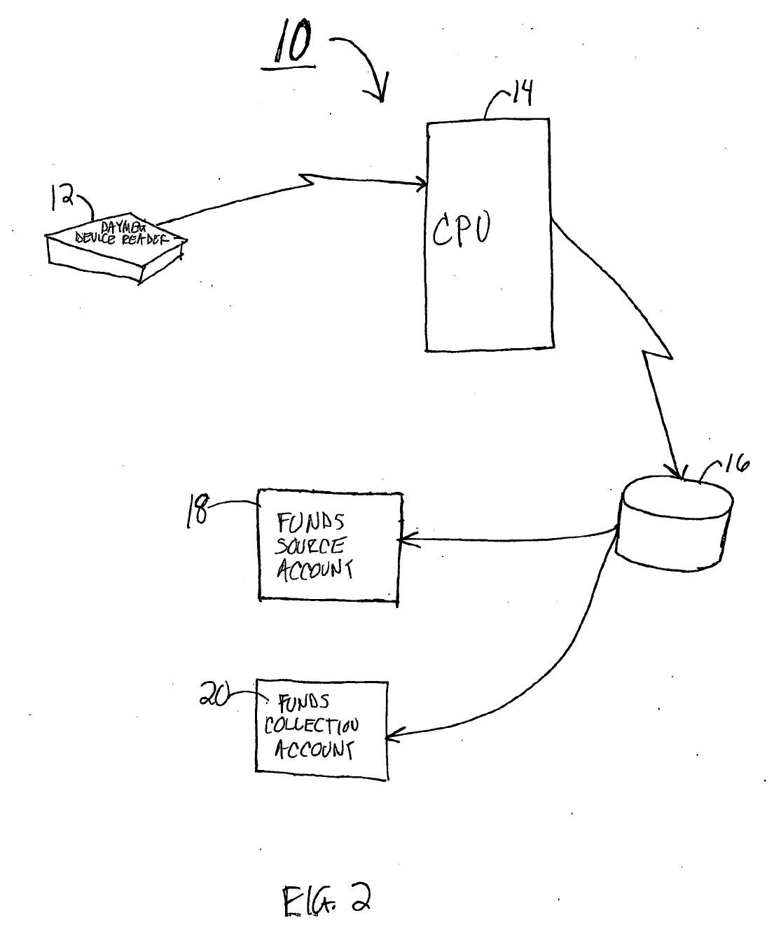

Referring now to FIG. 2, in some embodiments, the present invention is an electronic funds management system 10 that includes a computer 14 which is electronically linked to an electronic payment device reader 12. Computer 14 typically communicates with a financial institution 30 to provide account, account holder, and other relevant financial information. Computer 14 is in electronic communication with a funds source account 18 and with a funds collection account 20, through a server 16 configured to initiate the transfer of funds from funds source account 18 to funds collection account 20 in response an action at electronic payment device reader 12. While the invention is described here with reference to a system that includes a single electronic payment device reader 12, server 16, funds source account 18 and funds collection account 20, it is understood that more than one of any or all of these elements could be included. In accordance with the invention, in addition to a POS device, payment device reader 12 may be any device that can be configured to transmit electronic data and to communicate with a computer in response to a requested funds transfer, such as a smartcard reader, an Automated Teller Machine (“ATM”), an internet browser, a dedicated kiosk and similar devices.

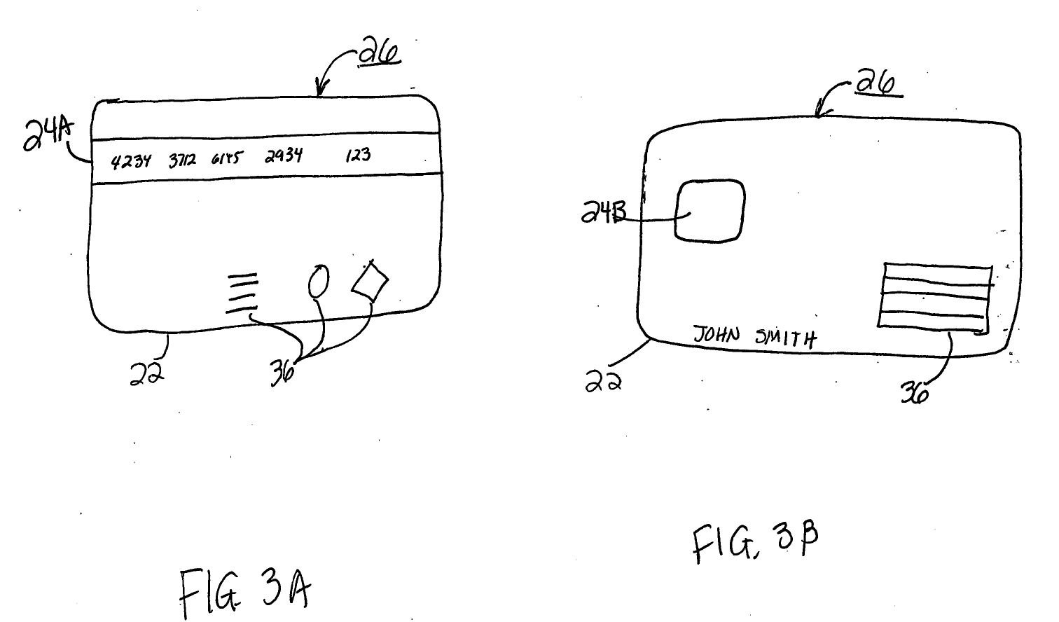

Several types of electronic payment devices 26 may be used with the invention. Turning to FIGS. 3A and 3B, electronic payment devices 26 that are used with the invention will typically include a rigid substrate 22 with a data storage region 24. Referring first to FIG. 3A, in some embodiments, payment device 26A may include a data storage region 24A in which data is magnetically stored, such as in a magnetic strip of the type used to store data on ATM, credit and debit cards. In other embodiments, payment device 26B may have a data storage region 24B that stores data in a solid state memory, such as that illustrated in FIG. 3B, as in a smartcard or similar device. Electronic payment devices may be provided in numerous other forms, such as small objects that can be attached to key rings, and stylus shaped/pen-like objects that can be carried in purses and pockets. While these types of devices will commonly be used to identify the account(s) that are accessible to a given individual or entity, it is to be understood that fingerprint and iris recognition and other technologies that may be used to identify an individual and his or her accounts could be used.

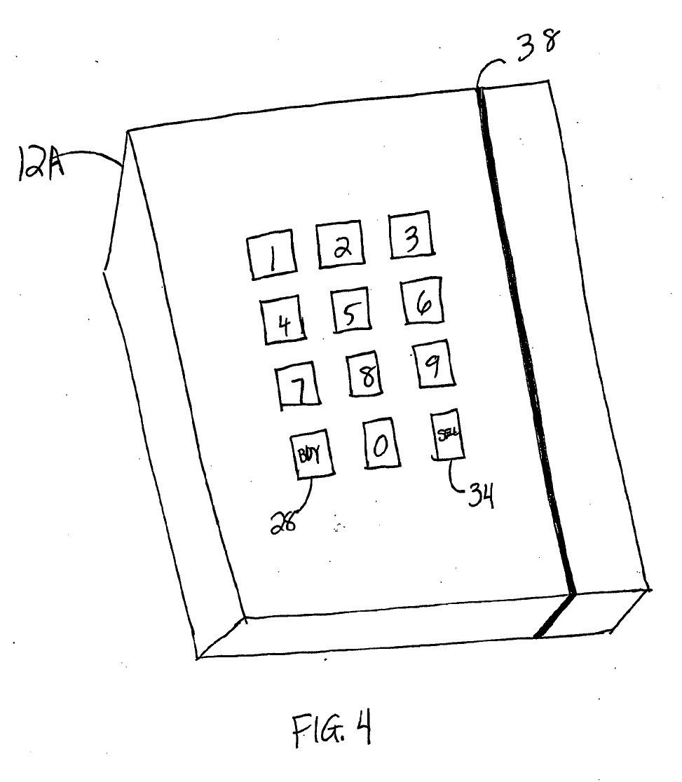

FIG. 4 shows an enhanced POS device 12A which may be used as an electronic payment device reader 12 in accordance with the invention. Most currently available POS devices have a 12-button keypad much like the one on the average telephone. While ten of the buttons on such a device are programmed to transmit designated digits or other information, two of these buttons remain unprogrammed. Other known POS devices include an entire row of unprogrammed buttons, and POS devices could be provided in numerous other configurations. In some embodiments of the invention, electronic payment device reader 12 is a POS device that includes software that enhances its functionality. In some embodiments, the enhanced functionality of this POS device enables merchants to connect to servers 16 that communicate with financial clearinghouse computers, using the previously unprogrammed buttons.

In accordance with embodiments of the invention, electronic payment device readers 12 include keys for entering funds and/or value transfer commands. In the embodiment shown in FIG. 4, these transfer commands may be entered at an enhanced POS device using a buy button 28 and/or a sell button 34. One action at reader 12A that initiates such a transfer includes the swiping of an electronic payment device 26 through slot 38 performed before, after or simultaneously with the pressing of buy button 28 or sell button 34. Another action that initiates such a transfer may include simply placing payment device 26 inside of or within a certain distance from reader 12, in conjunction with the entry of a fund transfer command, such as by pressing a buy button 28 or sell button 34. In any event, pressing the buy or sell button will enable the merchant to communicate with clearinghouse computers, and will ultimately result in the transfer of funds from a funds payable account to a funds receivable account, or in the transfer of value from a source virtual lock box 18 to a collection virtual lock box 20. Thus, the present invention employs unused buttons on a standard POS device without interrupting or otherwise disturbing the current operation of the device. Pressing of the buy and/or sell buttons in conjunction with the use of an electronic payment device enables an authorized merchant to transfer funds from a merchant commercial bank account to a financial clearinghouse master account, to denit the financial clearinghouse master account, to credit the merchant's clearinghouse account, enables the debiting of the merchant's clearinghouse account, the crediting of a customer's primary card and the debiting of a customer's primary account and the crediting of a companion account.

Conceptually, the various embodiments of the invention can be viewed as a system and method for transferring electronic “credits” that correspond to currency values. More specifically, a merchant can purchase electronic points from a financial clearinghouse and then sell those points to customers. The points have monetary value and can be converted to any currency. The clearinghouse merchant account posts credits that may be viewed as electronic “inventory” which is ready for sale to customers. The inventory can be stocked by simple request for additional credits from the financial clearinghouse through actual commercial bank funds transfers.

In some embodiments of the invention, the funds payable account is a checking account, a savings account, a line of credit, etc. that a merchant has set up with a commercial bank 30 or a similar financial institution. While a “merchant” will often be the operator of a commercial enterprise, in accordance with the invention, a merchant could be any entity that has access to an electronic payment device reader 12. When the merchant's account at a financial institution 30 serves as the funds payable account funds receivable account will typically be a master account at a financial clearinghouse 32.

It should be noted that as used herein, the phrase “financial institution” includes any institution that has been assigned or has access to a Bank Identification Number (“BIN”) approved by the American Banking Association or other equivalent entity, including, but not limited to commercial banks, credit unions and lending institutions. Financial clearinghouse 32 may be affiliated with a financial institution, it may be an independent entity, or it may be a third party card processor or similar entity. Generally speaking, financial clearinghouse 32 will be set up to receive funds transfer requests from various merchants, and to contact financial institutions 30 to accept funds transfers and to control the flow of value between virtual lock boxes as will be desribed below. In some embodiments, financial clearinghouse 32 may have a direct connection to merchants and/or the designated financial institution, while in other embodiments, either or both connections may be indirect (e.g., via the use of one or more intermediaries). Financial clearinghouse 32 will also have access to a BIN.

Generally speaking, a “lock box” is a virtual account that is set up at financial clearinghouse 32 where book entries of electronic credits and debits may be stored. Use of a lock box enables financial clearinghouse 32 to track value so that funds can be correctly dispersed. In one embodiment, financial clearinghouse 32 may set up two different types of virtual lock boxes: a source virtual lock box 18 from which value is typically deleted and a collection virtual lock box 20 to which funds may be credited. While the invention is shown as having two separate lock boxes, it should be understood that a single lock box could, and will often, be set up to accept both credits and debits. A master account at financial clearinghouse 32 may serve as both a funds receivable account and a source virsual lock box 18. In some embodiments, merchants will set up individual accounts at financial clearinghouse 32, which will serve as collection lock boxes 20. In accordance with embodiments of the invention, merchants may typically have access to one or more merchant cards, one type of electronic payment device 26 that may be used with the invention. Merchant cards may be read by reader 12 to identify the source virtual lock box 18 into which the credits from the master account at financial clearinghouse 32 should be credited, thereby increasing the value in the merchant's account. In fact, a single merchant card may be associated with more than one merchant account at clearinghouse 32, all of which are set up before the card is issued. The merchant will typically determine the amount of value that will be credited to her account, by transferring funds from her commercial bank (funds payable) account to the clearinghouse master (funds receivable) account, which results in the crediting of her source virtual lock box 18 with a value that corresponds to the amount of transferred funds. Both the funds transfer and value credit requests can be entered at payment device reader 12 in conjunction with the entering of the merchant identification information. Again, the merchant identification information may be preprogrammed into the POS or transmitted when the buy, sell or other funds transfer commands are executed, it may be extracted from a merchant card that is swiped through the POS, or it may be manually entered into the POS. A merchant may transfer funds at regular intervals (e.g. daily, weekly, monthly, etc.) or to transfer the required funds just before a consumer uses a customer card at a merchant's electronic payment device reader.

In some embodiments, clearinghouse master account, and thus, virtual lock boxes will be maintained at financial institutions 30. For example, financial clearinghouse 32 may set up source virtual lock boxes 18 at financial institutions 30 where one or more of the merchants with which it regularly conducts business maintain bank accounts. Setting up multiple accounts in this manner is likely to reduce or eliminate the fees that will have to be paid by financial clearinghouse 32 and/or its merchants, because many of the funds transfers between the merchant and financial clearinghouse 32 will be “intra-bank” funds transfers which do not pay these fees. Collection virtual lock boxes 20 may similarly be set up for the convenience of customers.

When merchant accounts serve as source virtual lock boxes 18, collection virtual lock boxes 20 will often be customer accounts that have been set up by one or more consumers at financial clearinghouse 32. In this case, merchant cards may be configured to post a credit to (i.e. to “load”), customer cards, another type of electronic payment device 26. Thus, in some embodiments, merchant cards will be programmed to debit a merchant's source virtual lock box 18 (e.g. a merchant's account) at the clearinghouse and credit the customer's collection virtual lock box 20. Customer cards will also be read by reader 12 to facilitate the transfer of funds.

In some embodiments of the invention, the issuance of the various types of electronic payment devices 26 is the result of a cooperative effort between a financial institution 30 and financial clearinghouse 32. Each card contains a unique (merchant or customer) identification (ID) number. In some embodiment the card will be a stored value card. Use of the card may also require a personal identification number (PIN). In some embodiments, the PIN will have four digits. However, it is possible to require the use of fewer or more digits. Each of these cards can be a read only or a read/write device (e.g. a smart card). While the use of a PIN may sometimes be advantageous, it should be noted that the use of a PIN may or may not be necessary to operate the invention For example, during “online” transactions, the merchant can connect to a functioning telecommunications network by swiping the customer's card, gain instant (i.e. online) approval. To complete these types of transactions, a merchant will typically verify that the consumer's signature, obtained at the point-of-sale, matches the one on the payment device. If the signature does not match, the merchant can refuse to complete the transaction. Also, if the card has been reported lost or stolen, the computer at financial clearinghouse (or institution where funds collection account is maintained) will reject the proposed transaction. When security measures such as these are already in place, the use of a PIN may not be necessary. On the other hand, machines such as ATMs already require users to input a PIN. When these devices are used, it may be more convenient allow for the entry of a PIN. In fact, in circumstances where off-line transactions and/or online debits that require the use of a PIN are more common, technologies like smart cards may be more desirable, since storing all of the required information in the card itself eliminates the requirement for phone lines, modems and other communications equipment.

It is to be understood that different types of customer cards will be used with the invention. In some embodiments, a primary card will be used to gain access to the funds in the clearinghouse master account that have been earmarked for a particular source 18 or collection 18 virtual lock box, while in other embodiments, a companion card may be used. A primary card will typically be used to identify the appropriate customer lock box and to debit that account, to transfer value to an associated companion account, and to enable a consumer to deposit and withdraw value into and out of the lock box. The primary card will usually be activated with the initial funding of the said card at clearinghouse 32. A companion card will typically be linked to a “companion account,” another type of funds collection account 20 that may also be set up at clearinghouse 32.

While a companion account may be set up in many ways, it will typically be set up to receive funds only via transfer from a primary account and will, therefore, usually not serve as a source virtual lock box 18. A companion account will typically be an account that is linked to or otherwise associated with the primary customer account. However, it may also be a segregated or similar portion of the primary customer account Companion cards will often be used at ATMs or other devices that can be used to withdraw cash from financial institutions. They may also be used at other locations, for example, those that accept credit and debit cards.

A consumer may obtain as many companion cards as desired once he has a primary card. The primary card holder could receive multiple companion cards which he distributes himself, or he could provide contact information to allow them to be distributed by financial clearinghouse 32 or financial institution 30. As stated earlier, a notification signal may be transmitted to the companion card holder when funds are being credited to the companion card. Exemplary notification signals include electronic mail notes, transmissions to pagers or personal digital assistants (PDAs), telephone calls and other wire and wireless communications. While customer accounts will often be set up at the same financial institution 30 where the master and merchant accounts are located, it is to be understood that such a scheme is not necessary, and that it is possible for two or all three accounts to be set up at different financial clearinghouses 32 that are capable of communicating.

In some embodiments, primary cards and companion cards each have 16 digit card numbers. In at least one such case, transferring money to a companion card requires a 32-bit combination. More specifically, a 16-digit primary card number and a 16-digit companion card number. In another embodiment, the digits from the primary card and a portion of the digits (e.g. the last four digits) of the companion card are required to load the companion card. That is, the proper combination of digits will be required to verify that the primary cardholder is attempting to transfer funds to the appropriate companion card. In order to access the posted credit on the customer card, the holder of the companion card must then provide its 16-digit companion card number. Used as described here, these two stored-value card numbers form an interlocking 32-digit security code. While the invention has been described with reference to primary and companion cards, it should be understood that the same principle's can be extended to merchant cards and the manner in which they are used with primary cards.

It should also be noted that while in one embodiment, funds are transferred from a commercial banking institution to a financial clearinghouse master account, and in another embodiment funds are debited from the financial clearinghouse master account and credited to customer accounts, the invention is not limited to these embodiments. For example, a customer could arrange to transfer funds directly from his or her own account at a commercial bank 30 to the master account at financial institution 30, and eliminate the requirement for intervention by a merchant. It is intended to embrace all such alternatives including credit card transfers, checks and money orders and is thus not limited to the embodiments that are described here.

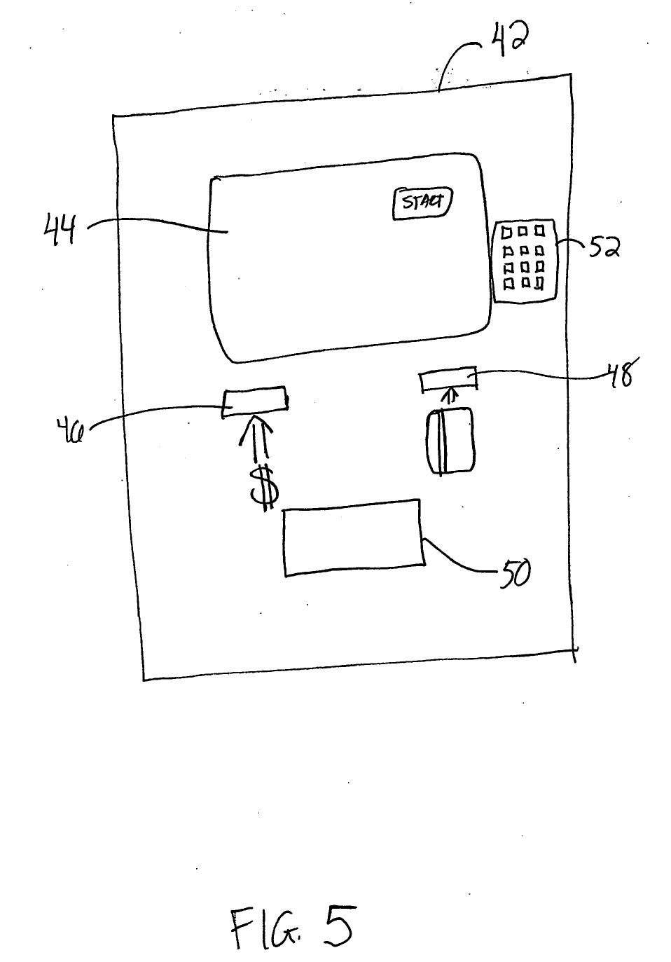

As illustrated in FIG. 5, another type of electronic payment device that may be used with the invention may be provided in a dedicated kiosk 42. In some embodiments, kiosk 42 has a user interface 44, a slot 46 for inserting cash, and a slot 48 for inserting an electronic payment device. In accordance with the invention, a consumer that wishes to load funds onto a primary card could approach the kiosk, insert cash into slot 46 and insert the card into slot 48. Funds and value transfer commands could be entered by pressing buy, sell, or other buttons on a keypad as described earlier, or they could be entered using a keyboard or by touching designated areas on the user interface (e.g., touchscreen) or in other appropriate ways. The consumer can then follow instructions that are displayed on user interface 44 to load the cash that has been entered at slot onto his primary card. In one such embodiment of the invention, the identifying information for the merchant account may be programmed into software that operates kiosk 42, thereby eliminating the need for a merchant card. Other embodiments may require a merchant to insert her card in slot 48 before the consumer inserts his primary card.

In other embodiments, kiosk 42 could be configured to dispense stored value electronic payment devices 26. These stored value payment devices could be issued in pre-determined increments or they could be issued in values that are requested by the consumer. When devices are dispensed in pre-determined increments, a customer may approach kiosk 42 and, following the directions on user interface 44, select an available dollar value. The customer can then insert the required payment into slot 48, and the card will be dispensed at tray 50. Payment devices 26 such as those described here could be used to load a primary or companion card, and could simply be discarded by the consumer when there are no remaining funds, or they could be re-loaded as described above. In still other embodiments, the customer may approach kiosk 42 and enter a desired dollar value using keypad 52. The customer may then insert his payment at slot 48, to receive an electronic payment device 26 loaded with the selected value (and any change) at tray 50.

While the invention has been described here as to accepting cash at slot 48, it is to be understood that a kiosk 42 could be configured to accept credit card, debit cards and similar devices. Kiosk 42 could also be configured to accept other electronic payment devices 26. For example, a customer could approach kiosk 42 to transfer funds from his primary account to a companion account. Similarly, a merchant could approach kiosk 42 to transfer funds from her commercial bank to the master account at clearinghouse 32, having her individual account credited at the same or an affiliated clearinghouse.

It should also be understood that while the invention has been described here as using a kiosk 42 to dispense disposable stored-value elect payment devices 26, it is not limited to such embodiments. Disposable electronic payment devices 26 with pre-stored or user requested values could also be purchased from merchants, from financial clearinghouse 32 or from commercial bank 30. In some embodiments, inactive pre-stored electronic payment devices could be sent to potential customers via direct mail or via fulfillment of requests that have been made over the internet, telephone, etc. The customer could then contact a merchant financial clearinghouse or designee to arrange to load and activate the payment device.

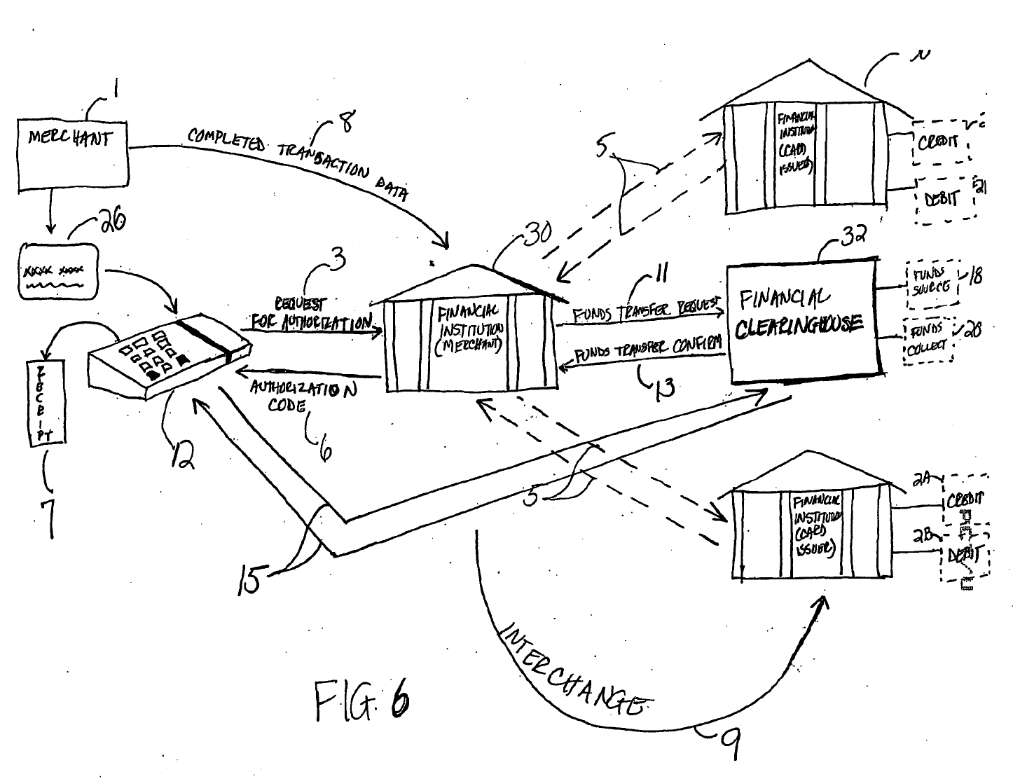

The present invention can be used to transfer funds and make electonic point of sale payments using the worldwide financial transactions network as illustrated in FIG. 6. In accordance with one embodiment of the invention, a merchant 1 swipes a buyer's electronic payment device 26 through an electronic payment device reader 12, and the amount of the purchase is entered manually by the merchant, transmitted directly from a cash register or obtained in some other appropriate manner. A request for authorization, which includes the purchase amount and customer account identifying information is transmitted to the merchant's financial institution 30 in response to a funds transfer command, as illustrated by arrow 3.

In one embodiment, information that is included in the request for authorization identifies the electronic payment device 26 as one that is linked to a virtual lockbox at financial clearinghouse 32, rather than to an account at a traditional banking institution. Thus, instead of simply forwarding the request for authorization to a card issuing bank, the merchant's financial institution 30 may transmit a value transfer or payment request to financial clearinghouse 32 as indicated by arrow 11. If the customer has enough funds in his account, financial clearinghouse 32 can authorize the transaction, place a hold on value the cardholder's lock box for the amount of the sale, generate an authorization code and transmit the authorization code to the merchant's financial institution as indicated by arrow 13. If the customer does not have enough available value, financial clearinghouse 32 can refuse to authorize the sale, which would typically mean that no authorization code will be generated, and the merchant will cancel the sale. Once the merchant's bank receives the authorization code and sends it to the electronic payment device reader 12 that requested the authorization, the electronic payment device reader 12 may then print out a sales draft 7 which can be signed by the customer, or it may accept a PIN or other information that positively identifies the payment device holder.

As in the prior art system of FIG. 1, value may be transferred from the customer's account immediately or the transaction may be finalized at some later point in time. As explained earlier, the merchant may first choose to verify the transactions that have occurred, using the authorizations that have been stored in electronic payment device reader 12. The merchant may then transmit the data from each completed transaction to its own financial institution as shown by arrow 8, which can perform an interchange with financial clearinghouse 32, typically, but not necessarily, at the same time it performs the interchange with the various card issuing financial institutions 30, for each transaction as shown by arrow 9. Financial clearinghouse 32 may then transfer actual funds in the authorized amounts by converting the value in the consumers' source virtual lock box to cash and transferring funds to the merchant's financial institution, who can deposit the funds in the merchant's account.

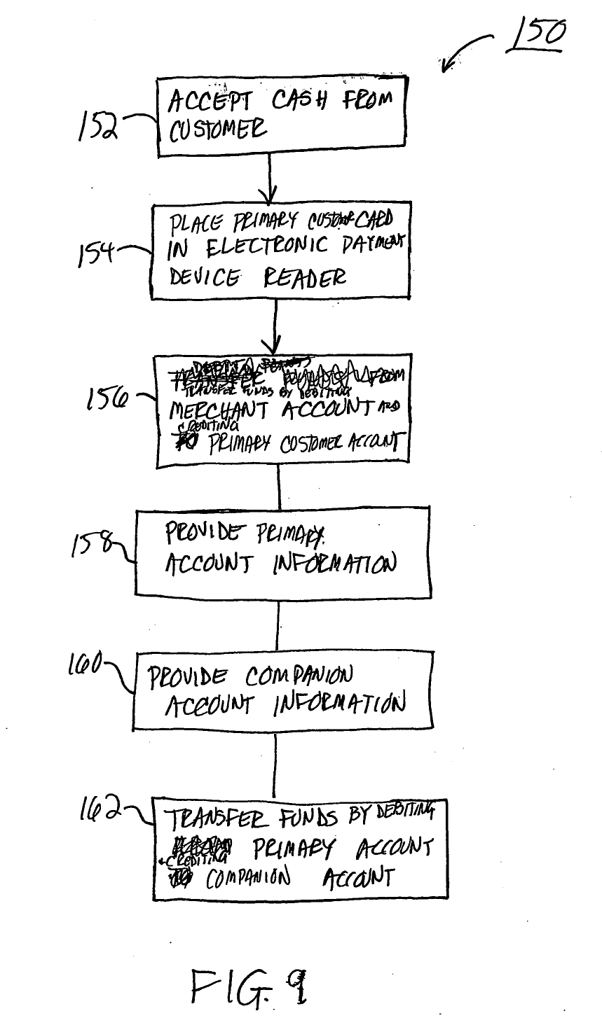

Thus, as shown in FIG. 9, the merchant's financial institution 30 will typically have access to card issuing financial institutions 30 in addition to financial clearinghouse 32. Thus, the present invention will not interfere with the ability of a merchant to complete credit or debit card transactions. Rather, it will enable merchants to process an additional type of transaction, namely, an electronic funds transfer for a customer who does not have access to formal, institutional banking relationships.

The system illustrated in FIG. 6 can also be used to load electronic payment devices and to allocate funds that have been transferred to financial clearinghouse 32 from a merchant. In one embodiment, a merchant may enter an amount of funds to be transferred and provide merchant account identifying information either directly from storage linked electronic payment device reader 12 or by swiping a merchant's electronic payment device 26 through reader 12. In one embodiment, buy button 28 is then activated to transmit a funds transfer request directly from electronic payment device reader 12 to financial clearinghouse 32. Activation of buy button 28 causes funds to be transferred from the merchant's account at a financial institution 30 to the master account at financial clearinghouse 32. In another embodiment, sell button 34 is activated after the merchant enters the amount of funds to be transferred and provides her account identifying information. Activation of sell button 34 transmits a value transfer request directly from electronic payment device 12 to financial clearinghouse 32. However, activation of sell button 34 causes value in an amount that corresponds to funds in financial clearinghouse 32 that have been earmarked for a particular merchant, to be credited to a customer account. Assuming ample funds in the clearinghouse master account have been posted to the merchant before this request is processed, financial clearinghouse 32 will credit the customer virtual lock box, and debit the merchant's lock box and a confirmation will be returned to electronic payment device reader 12. If the merchant does not have a sufficient amount of value in the clearinghouse master account, the value will not be transferred and the merchant will have to transfer funds from her commercial bank account or other source to the clearinghouse master account before she can transfer credits to her customer. As explained earlier, a funds transfer request may also be denied if the customer has provided an invalid card. Once the transaction is confirmed, the customer can use the electronic payment device to conduct electronic transactions as desired.

In still another embodiment, the system illustrated in FIG. 6 can be used to transfer value from a customer's primary account to his companion account(s). For example, the customer can hand the merchant his primary payment device 26, and when the merchant swipes it through device reader 12, enters the appropriate amount, identifying information for the companion account and presses sell button 34, a funds transfer request will be transmitted directly from device reader 12 to financial clearinghouse 32. The request to transfer value from a primary account to a companion account will be approved as long as there are sufficient credits in the primary account. Otherwise, the primary account holder will have to give cash to the merchant and increase the amount of available credits in his account before value can be transferred to the companion account. Once the transaction is confirmed, the companion can use the companion payment device 26 to conduct electronic transactions. The system could also be used to transfer funds from an account at a financial institution to the clearinghouse master account, or if desired, to customer accounts.

While the above described aspects of the invention have been described using particular buttons on a POS device and as transferring value between particular accounts in response to the activation of those buttons (e.g. from a merchant bank account to a financial clearinghouse account in response to activation of a sell button), it is to be understood that the invention may be practiced using many other combinations of accounts and funds transfer commands.

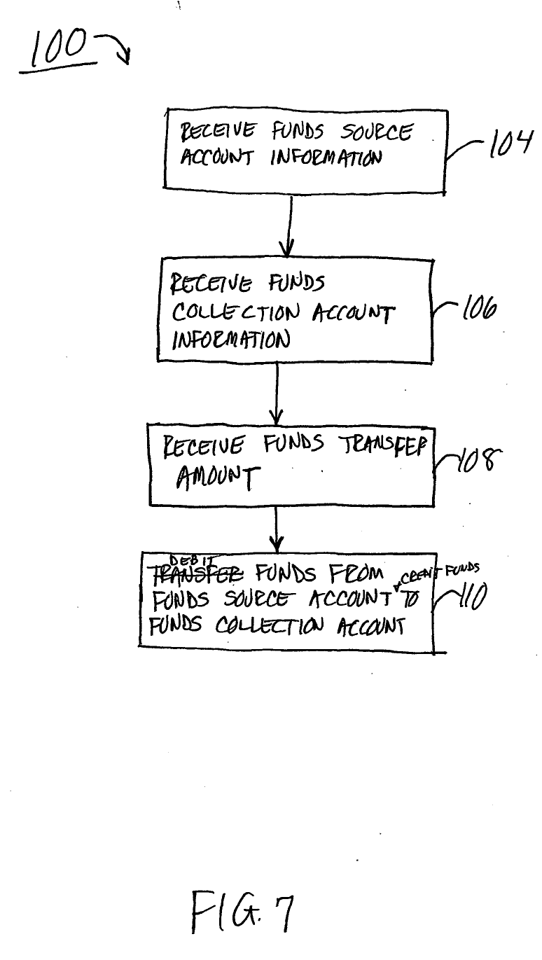

Turning now to FIG. 7, in some embodiments, the invention includes a method 100 of electronically transferring funds. Method 100 generally includes receiving information about a funds payables account as indicated in block 104, receiving information about a funds receivables account as indicated in block 106 and receiving information about a funds transfer amount as indicated in block 108, from an electronic payment device reader 12. As described earlier, in some embodiments, the funds payables account is controlled by financial institution. Information that identifies the funds payables account may be pre-stored in electronic payment device reader 12, or it may be stored in a data storage region 24 of an electronic payment device 26. Funds from the identified location are then credited to a funds receivables account in response to an action at electronic payment device reader 12 as indicated in block 110. One example of such an action includes entering a funds transfer command.

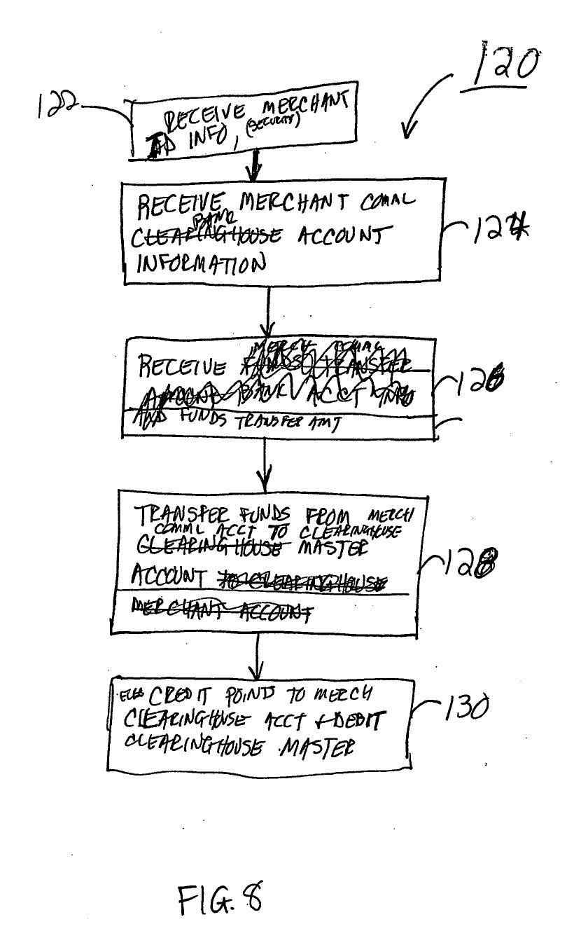

Turning now to FIG. 8, in one embodiment, a merchant may have a clearinghouse account which serves as a funds collection account, while the master account at financial clearinghouse 32 serves as the funds source account. In some embodiments of the invention, the method of electronically transferring funds includes receiving information that identifies the merchant's clearinghouse account at financial clearinghouse 32, as indicated in block 122. Financial clearinghouse 32 will also receive a request to transfer an amount of funds as shown in block 124, and the requested amount will be debited from the financial clearinghouse master account to the merchant clearinghouse account as indicated in block 130.

In many of the above described embodiments of the invention, the merchant will have often authorized the transfer of funds from the merchant's commercial bank to the financial clearinghouse 32 at some time prior to the time the consumer approaches the merchant. While value will typically be credited to the merchant's financial clearinghouse account prior to loading the consumer's card, it should be understood that the invention is not limited to such use. For example, the merchant could arrange with clearinghouse 32 to create a line of credit that will allow her to repay the funds that she has provided to consumers during a given period.

Referring to FIG. 9, the consumer may then approach a merchant, hand her cash and have funds loaded onto his card. In such a case, the merchant's account at clearinghouse 32 serves as the funds source account 18 and the customer account serves as the funds collection account 20. In these embodiments, the merchant may accept an amount of cash that corresponds to the dollar amount that he wants to load onto his card from the consumer as indicated in block 152. The amount of cash that is handed to the merchant may equal the exact amount that the consumer wishes to load, or it may be an amount that includes a fee or incentive. The merchant will then accept the customer card from the consumer, and place it in (or near) reader 12 as indicated in block 154. While the invention has been described as incorporating fees and/or incentives at the time the cash is handed to the merchant, it is to be understood that they could be assessed at some other time. For example, fees could be collected at the time the cardholder debits funds from the account, or at any other acceptable time.

As stated earlier, the information stored in data storage region 24 of the customer card will typically include an identifier for the consumer's account at financial clearinghouse 32. The electronic payment device reader will read the customer card when it is placed into payment device reader 12, to identify the customer account into which the funds from the merchant account should be directed. The merchant enters the funds transfer command, which may include pressing a “sell” or other designated button or key on the POS device, ATM terminal, internet browser or other device reader 12 to complete the transfer as shown in block 156.

Certain types of customer accounts may also serve as both a funds source accounts 18 and funds collection accounts 20. For example, when a consumer chooses to obtain companion accounts, the primary accounts may serve as both funds source and funds collection accounts. Still referring to FIG. 9, primary and companion account information is received as indicated in blocks 158 and 160. This typically, but not necessarily occurs when the merchant accepts the primary card and then obtains at least some portion of the companion account number. This may be accomplished by the merchant's acceptance of a duplicate of the companion card, by asking the primary card holder for the relevant portion of the companion card, by selecting the reference number for a sub-account when prompted by electronic device reader. 12, or by any other suitable method. At the primary cardholder's direction, the merchant will then enter the amount of the funds to be debited, and enter the funds transfer command, thereby crediting value to the companion account as indicated in block 162.

It is, therefore, apparent that there has been provided, in accordance with the present invention, an electronic funds transfer method and system. While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

I claim:

1. A method of effecting an electronic funds transfer, comprising:
receiving a value transfer request transmitted from an electronic payment device reader, wherein said value transfer request includes identifying information for a source virtual lock box and a collection virtual lock box, and includes a value transfer amount that corresponds to a value of barter received by a user of said electronic payment device reader to cause transmission of said value transfer request; and
electronically debiting value that corresponds to said value transfer amount from said source virtual lock box and crediting said value to said collection virtual lock box in accordance with said value transfer request.

1.1 A method as claimed in claim 1 further comprising:
Receiving a funds transfer request transmitted from an electronic payment device reader, wherein said value transfer request includes identifying information for a payables account and a receivables account, and includes a value transfer amount that corresponds to a value of barter received by a user of said electronic payment device reader to cause transmission of said value transfer request; and
electronically transferring said funds transfer amount from said funds payable account to said funds receivable account in accordance with said funds transfer request

2. A method as claimed in claim 1 wherein said received barter is currency.

2.1 A method as claimed in claim 1.1 wherein said received barter is currency

3.1. A method as claimed in claim 1.1 wherein said funds are transferred in response to entry of a value transfer command at said electronic payment device.

3 A method as claimed in claim 1 wherein said value is transferred in response to entry of a value transfer command at said electronic payment device.

4. A method as claimed in claim 3 wherein value transfer command is entered by pressing a button on said electronic payment device.

5. A method as claimed in claim 3 wherein value transfer command is entered by pressing a key on a keyboard associated with said electronic payment device.

6. A method as claimed in claim 3 wherein value transfer command is entered by pressing a key on a keypad associated with said electronic payment device.

7. A method as claimed in claim 3 wherein value transfer command is entered by touching a region of a touch screen associated with said electronic payment device.

8. A method as claimed in claim 1.1 wherein said funds payable account is a financial institution account.

9. A method as claimed in claim 8 wherein said funds receivable account is a financial clearinghouse master account.

10. A method as claimed in claim 1, wherein said source virtual lock box represents a clearinghouse master account

11. A method as claimed in claim 10, wherein said collection virtual lock box represents a merchant clearinghouse account.

12. A method as claimed in claim 10, wherein said collection virtual lock box represents a primary customer account.

13. A method as claimed in claim 1 wherein said source virtual lock box represents a merchant clearinghouse account, and said collection virtual lock box represents a primary customer account.

14. A method as claim in claim 13, further comprising:
debiting said value transfer amount from said merchant clearinghouse account and crediting primary stored value device associated with said primary customer account with said value transfer amount.

15. A method a claimed in claim 13 further comprising debiting said value transfer amount from said primary customer account and crediting a companion customer account with said value transfer amount.

16. A method as claimed in claim 15 further comprising generating a funds transfer notification signal when funds have been credited to said companion customer account.

17. A method as claimed in claim 16 wherein said credit notification signal is an electronic mail note.

18. A method as claimed in claim 16 wherein said credit notification signal is an indicator at an electronic pager.

19. A method as claimed in claim 16 wherein said credit notification signal is an indicator at a personal digital assistant.

20. A method as claimed in claim 16 wherein said credit notification signal is transmitted over telephone lines.

21. A method of effecting an electronic funds transfer, comprising:
accepting barter from a customer;
transmitting funds transfer information from an electronic payment device reader, wherein said funds transfer information includes source virtual lock box identifying information, collection virtual lock box identifying information and a request to transfer value in an amount that corresponds to an amount of said accepted barter; and
transferring said requested value from a location identified in said source virtual lock box information to a location identified in said collection virtual lock box location in accordance with said value transfer request.

21.1 A method of effecting an electronic funds transfer, comprising:
accepting barter from a customer, transmitting funds transfer information from an electronic payment device reader, wherein said funds transfer information includes funds payable account identifying information, funds receivable account identifying information and a request to transfer funds in an amount that corresponds to an amount of said accepted barter; and
transferring said requested funds from a location identified in said funds payable account information to a location identified in said funds receivable account information in accordance with said funds transfer request.

22. A method as claimed in claim 21 wherein said barter is cash.

23. A method as claimed in claim 21.1 wherein said funds payable account identifying information identifies an account at a financial institution.

24. A method as claimed in claim 23 wherein said funds receivable account information identifies a master account at a financial clearinghouse.

25. A method as claimed in claim 21, wherein source virtual lock box identifying information identifies a master account at a financial clearinghouse.

26. A method as claimed in claim 25, wherein collection virtual lock box identifying information identifies a merchant account at a financial clearinghouse.

27. A method as claimed in claim 21 further comprising debiting said value from said clearinghouse master account and crediting said value to said merchant clearinghouse account.

28. A method as claimed in claim 21 wherein said source virtual lock box identifying information identifies a merchant account at a financial clearinghouse and said collection virtual lock box identifying information identifies a primary customer account at said financial clearinghouse.

29. A method as claimed in claim 28 further comprising debiting said value from said financial clearinghouse merchant account and crediting said value to a stored value device associated with said primary customer account.

30. A method a claimed in claim 29 further comprising debiting said value from said primary customer account and crediting said value to a companion stored value device associated with a companion customer account.

31. A method as claimed in claim 30 further comprising generating a credit notification signal when said value has been credited to said companion stored value device.

32. A method as claimed in claim 31 wherein said credit notification signal is an electronic mail note.

33. A method as claimed in claim 31 wherein said credit notification signal is an indicator at an electronic pager.

34. A method as claimed in claim 31 wherein said credit notification signal is an indicator at a personal digital assistant.

35. A method as claimed in claim 31 wherein said credit notification signal is transmitted over telephone lines.

36. A method as claimed in claim 21 wherein said electronic payment device reader is a point-of-sale device.

37. A method as claimed in claim 21 wherein said electronic payment device reader is a smartcard reader.

38. A method as claimed in claim 21, wherein said value transfer information is transmitted in response to entry of a funds transfer command at said electronic payment device reader.

39. A method as claimed in claim 21 wherein said electronic payment device reader is a dedicated kiosk.

40. An electronic funds management system, comprising:
one or more source virtual lock boxes configured to supply funds and one or more collection virtual lock boxes configured to receive funds;
a computer in electronic communication with one or more electronic payment device readers, with said one or more source virtual lock boxes and with said one or more collection virtual lock boxes; and
a server configured to initiate the transfer of funds from at least one of said source virtual lock boxes to at least one of said collection virtual lock boxes in response to an instruction transmitted from said electronic payment device reader to thereby cause said computer to complete said value transfer.

41. An electronic funds management system as claimed in claim 40 wherein an amount of said value transfer corresponds to a value of received barter.

42. An electronic funds management system as claimed in claim 41 wherein said received barter is currency.

43. An electronic funds management system as claimed in claim 40 wherein said electronic payment device reader action includes entering a value transfer command.

44. An electronic funds management system as claimed in claim 40.1 wherein a funds payable account is located at a financial institution.

45. An electronic funds management system as claimed in claim 43, wherein said funds receivable account is a clearinghouse master account.

46. An electronic funds management system as claimed in claim 42, wherein said source virtual lock box represents a clearinghouse master account.

47. An electronic funds management system as claimed in claim 45, wherein said collection virtual lock box represents a clearinghouse merchant account.

48. An electronic funds management system claimed in claim 46, wherein value is debited from said clearinghouse master account and credited to said clearinghouse merchant account in response to a funds transfer command received from said electronic payment device reader.

49. An electronic funds management system as claimed in claim 43, wherein said collection virtual lock box represents a primary customer account.

50. An electronic funds management system as claimed in claim 48, wherein said collection virtual lock box represents a companion customer account.

51. An electronic funds management system as claimed in claim 50, where value is debited from said primary customer account and credited to a stored value device associated with said companion customer account in response to a value transfer command received from said electronic storage device reader.

52. An electronic funds management system as claimed in claim 40 wherein said source virtual lock box represents a financial clearinghouse master account and said collection virtual lock box represents a merchant account.

53. An electronic funds management system as claimed in claim 40, wherein said source virtual lock box represents a merchant clearinghouse account and said collection virtual lock box represents a primary customer account.

54. An electronic funds management system as claimed in claim 40, wherein said funds payables account is a financial clearinghouse master account and said funds receivables account is a primary customer account.

55. An electronic funds management system as claimed in claim 40 wherein said source virtual lock box represents a primary customer account and said collection virtual lock box represents a companion customer account.

56. An electronic funds management system as claimed in claim 40 further comprising one or more stored value cards, readable by said electronic payment device reader, wherein reading of at least one of said stored value cards by said electronic payment device reader identifies a source virtual lock box involved in said value transfer.

57. An electronic funds management system as claimed in claim 56 further comprising at least one stored value card, readable by said electronic payment device reader, wherein reading of at least one of said stored value cards by said electronic payment device reader identifies a collection virtual lock box involved in said value transfer

59. An electronic funds management system as claimed in claim 40 further comprising at least one electronic payment device that includes a rigid substrate with a data storage region in which virtual lock box identifying information is stored.

60. An electronic funds management system as claimed in claim 59 wherein said virtual lock box identifying information is magnetically stored in at least one of said data storage regions.

61. An electronic funds management system as claimed in claim 59 wherein said virtual lock box identifying information is stored in a solid-state memory.

62. An electronic funds management system as claimed in claim 40 wherein at least one of said electronic payment devices is a smartcard.

63. An electronic payment device reader configured to provide a value transfer request that includes source virtual lock box identifying information, collection virtual lock box identifying information and a value transfer request that includes a funds transfer amount, wherein a transmission of said value transfer request data from said electronic payment device reader causes the electronic debiting of value from said source virtual lock box and the crediting of value to said collection virtual lock box.

63.1 An electronic payment device reader configured to provide a funds transfer request that includes funds payable account identifying information, funs receivable account information and a funds transfer request that includes a funds transfer amount, wherein a transmission of said funds transfer request data from said electronic payment device reader causes the electronic transfer of funds from said funds payable account to said funds receivable account.

64. An electronic payment device reader as claimed in claim 63 wherein said value transfer request is obtained by extracting data from said value transfer request.

65. An electronic payment device reader as claimed in claim 63 wherein said electronic payment device reader is a point-of-sale device that includes a button that is programmed to transmit said value transfer request.

66. An electronic payment device reader as claimed in claim 63 wherein said electronic payment device reader is located on a kiosk.

67. An electronic payment device reader as claimed in claim 63 wherein said electronic payment device reader includes a keypad with a button that is programmed to transmit said value transfer request.

68. An electronic payment device reader as claimed in claim 63 wherein said electronic payment device reader includes a keyboard with a button that is programmed to transmit said value transfer request.

69. An electronic payment device reader as claimed in claim 63 wherein said electronic payment device reader includes a touch screen with a region that is can be touched to transmit said value transfer request.

70. A method of transferring funds, comprising:
accepting barter from a customer;
obtaining identifying information for a merchant account;
obtaining identifying information for a customer account;
entering a value transfer command which includes a value transfer amount that corresponds to a value of said accepted barter and includes said customer account identifying information and said merchant account identifying information; and
transmitting said value transfer command to a financial clearinghouse to cause said financial clearinghouse to transfer said value transfer amount from said merchant account to said customer account.

70. A method as claimed in claim 69 wherein said accepted barter is currency.

71. An electronic payment device reader as claimed in claim 69 wherein said value transfer command is entered at a point-of-sale device that includes a button that is programmed to transmit said customer account identifying information.

72. An electronic payment device reader as claimed in claim 70 wherein said value transfer command is entered at a kiosk.

73. An electronic payment device reader as claimed in claim 70 wherein said value transfer command is entered using a keypad with a button that is programmed to transmit said customer account identifying information.

74. An electronic payment device reader as claimed in claim 70 wherein said electronic payment device reader includes a keyboard with a button that is programmed to transmit said customer account identifying information.

75. An electronic payment device reader as claimed in claim 70 wherein said electronic payment device reader includes a touch screen with a region that is can be touched to transmit said customer account identifying information.

76. A method of transferring funds, comprising:
accepting barter from a customer,
obtaining primary account identifying information from a primary stored value device;
obtaining companion account identifying information from a companion stored value device;
transmitting a value transfer command to a financial clearinghouse, to cause said financial clearinghouse to transfer said value transfer amount from said primary account to said companion account, wherein said value transfer command includes said primary account identifying information, said companion account information and a value transfer amount that corresponds to a value of said accepted barter.

77. A method as claimed in claim 76 wherein said accepted barter is currency.

78. A method as claimed in claim 76 further comprising generating a funds transfer notification signal when funds are transferred to said companion customer account.
